(19) United States
(12) Patent Application Publication
(10) Pub. No.: US 2018/0079023 A1
(43) Pub. Date: Mar. 22, 2018

(54) METHODS AND SYSTEMS FOR BRUSHLESS WELDER GENERATOR

(71) Applicant: LINCOLN GLOBAL, INC., CITY OF INDUSTRY, CA (US)

(72) Inventors: EDWARD A. ENYEDY, EASTLAKE, OH (US); ANDREU P. MECKLER, MENTOR, OH (US); ADAM HRUSKA, CHARDON, OH (US)

(21) Appl. No.: 15/270,573

(22) Filed: Sep. 20, 2016

(51) Int. Cl. B23K 9/10

(52) U.S. Cl. CPC B23K 9/1012; B23K 9/1081; B23K 9/1043

(57) ABSTRACT

The invention described herein generally pertains to a system and method related to an engine driven welding device that includes a first brushless generator component configured to produce a first electrical current for use with a welding operation and a second brushless generator component configured to produce a second electrical current for use as auxiliary power. The first brushless generator component can be a permanent magnet generator and the second brushless generator component can be an asynchronous generator, each being coupled to a shaft of an engine within the engine driven welding device. A portion of the first electrical current produced can be fed into the second brushless generator component to act as an exciter, wherein the frequency of the portion of the first electrical current can be matched to the frequency of the second brushless generator component.

### TECHNICAL FIELD

In general, the present invention relates to an engine driven welding device that includes a first brushless generator to generate a power for a welding circuit and a second brushless generator to generate a power for auxiliary power.

### BACKGROUND OF THE INVENTION

Frequently, welding is required where supply power may not be readily available. As such, the welding power supply may be an engine driven welding power supply incorporating a generator. The generator may supply power to the welder as well as to other power tools as may be needed on site.

Traditional welding-type apparatus can be broken into two basic categories. The first category receives operational power from transmission power receptacles, also known as static power. The second is portable or self-sufficient, standalone welders having internal combustion engines, also known as rotating power. Rotating power driven welders operate by utilizing power generated from engine operation. As such, engine driven welders and welding-type apparatus allow portability and thus fill an important need. Engine driven welders use generators to produce power for welding operation and auxiliary power. A single generator produces each type of power by utilizing two sets of stator windings in the rotor/stator assembly, wherein each set is isolated from one another by being placed in particular slots. Yet, this, among other factors, increases the cost of fabricating engine driven welders and such configuration can be cumbersome to maintain for an end-user. Accordingly, an improved welding device, system, or methodology addressing these concerns is needed.

### SUMMARY OF THE INVENTION

In accordance with an embodiment of the present invention, a welding device is provided that includes a motor-driven welder assembly including an engine that is configured to rotate a shaft. The welding device can include a first generator component having a first rotor coupled to the shaft and a first stator that houses the first rotor, wherein a rotation from the shaft rotates the first rotor to generate a first electrical current. The welding device further includes a second generator component having a second rotor coupled to the shaft and a second stator that houses the second rotor, wherein the rotation from the shaft rotates the second rotor to generate a second electrical current. The first generator component and the second generator component are brushless. The second electrical current can be used as an auxiliary power source and a first portion of the first electrical current is used as a power source for the welding device to perform a welding operation.

In accordance with an embodiment of the present invention, a method is provided that includes at least the steps of: producing a first electrical current based on a rotation of a first brushless rotor/stator assembly from a shaft coupled to an engine; producing a second electrical current based on a rotation of a second brushless rotor/stator assembly from the shaft; delivering a first portion of the first electrical current for use with a welding operation; delivering the second electrical current for use as an auxiliary power source; and feeding a second portion of the first electrical current to the second brushless rotor/stator assembly, wherein a first frequency of the second portion is matched to a second frequency of the second brushless rotor/stator assembly.

In accordance with an embodiment of the present invention, a welder system is provided that includes at least the following: means for rotating a shaft; a first generator component having a first rotor coupled to the shaft and a first stator that houses the first rotor, wherein a rotation from the shaft rotates the first rotor to generate a first electrical current; a second generator component having a second rotor coupled to the shaft and a second stator that houses the second rotor, wherein the rotation from the shaft rotates the second rotor to generate a second electrical current; the first generator component and the second generator component are brushless; the second electrical current is used as an auxiliary power source; a first portion of the first electrical current is used as a power source for the welding device to perform a welding operation; and a field controller component that is configured to convert a second portion of the first electrical current to a frequency that matches a frequency the second generator component is running and excites the second generator component using the converted second portion.

These and other objects of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 illustrates a welding device;

FIG. 2 illustrates a welding device that is portable;

FIG. 3 illustrates a welding device affixed to a trailer for mobility;

FIG. 4 illustrates a welding device;

FIG. 5 illustrates a welding device without an exterior casing;

FIG. 6 is a block diagram illustrating an aspect of a welding device that includes a first generator and a second generator;

FIG. 7 is a block diagram illustrating an aspect of a welding device that uses two brushless generators coupled to a shaft;

FIG. 8 is a block diagram illustrating an embodiment of a circuit component utilized with the subject innovation;

FIG. 9 is a block diagram illustrating an embodiment of a field controller component used with a welding device; and

FIG. 10 is a flow diagram of a methodology of utilizing two brushless generators to generate power for a welding operation and an auxiliary power source respectively.

### DETAILED DESCRIPTION OF THE INVENTION

Embodiments of the invention relate to methods and systems that relate to an engine driven welding device that includes a first brushless generator component configured to produce a first electrical current for use with a welding operation and a second brushless generator component configured to produce a second electrical current for use as an auxiliary power source. The first brushless generator component can be a permanent magnet generator and the second brushless generator component can be an asynchronous generator, each being coupled to a shaft of an engine within the engine driven welding device. A portion of the first electrical current produced can be fed into the second brushless generator component to act as an exciter, wherein the frequency of the portion of the first electrical current can be matched to the frequency of the second brushless generator component.

The subject innovation can be used with any suitable engine driven welder, engine driven welding system, engine driven welding apparatus, a welding system powered by an engine, a welding system powered by a battery, a welding system powered by an energy storage device, a hybrid welder (e.g., a welding device that includes an engine driven power source and an energy storage device or battery), or a combination thereof. It is to be appreciated that any suitable system, device, or apparatus that can perform a welding operation can be used with the subject innovation and such can be chosen with sound engineering judgment without departing from the intended scope of coverage of the embodiments of the subject invention. The engine driven welder can include a power source that can be used in a variety of applications where outlet power is not available or when outlet power will not be relied on as the sole source of power including portable power generation, backup power generation, heating, plasma cutting, welding, and gouging. The example discussed herein relates to welding operations, such as, arc welding, plasma cutting, and gouging operations. It is to be appreciated that a power source can generate a portion of power, wherein the portion of power is electrical power. It is to be appreciated that “power source” as used herein can be a motor, an engine, a generator, an energy storage device, a battery, a component that creates electrical power, a component that converts electrical power, or a combination thereof.

“Welding” or “weld” as used herein including any other formatives of these words will refer to depositing of molten material through the operation of an electric arc including but not limited to submerged arc, GTAW, GMAW, MAG, MIG, TIG welding, any high energy heat source (e.g., a laser, an electron beam, among others), or any electric arc used with a welding system. Moreover, the welding operation can be on a workpiece that includes a coating such as, but not limited to, a galvanized coating.

“Component” or “Controller” as used herein can be a portion of hardware, a portion of software, or a combination thereof that can include or utilize at least a processor and a portion of memory, wherein the memory includes an instruction to execute.

It is to be appreciated that the above description uses “voltage,” “current,” or “power” and that such description of each can be interchangeable based on the equations V=I/R, where V is voltage, I is current, and R is resistance and P=V*I, where P is power, V is voltage, and I is current. Moreover, the voltages or currents described above can be averages based on fluctuation.

While the embodiments discussed herein have been related to the systems and methods discussed above, these embodiments are intended to be exemplary and are not intended to limit the applicability of these embodiments to only those discussions set forth herein. The control systems and methodologies discussed herein are equally applicable to, and can be utilized in, systems and methods related to arc welding, laser welding, brazing, soldering, plasma cutting, waterjet cutting, laser cutting, and any other systems or methods using similar control methodology, without departing from the spirit or scope of the above discussed inventions. The embodiments and discussions herein can be readily incorporated into any of these systems and methodologies by those of skill in the art. By way of example and not limitation, a power supply as used herein (e.g., welding power supply, among others) can be a power supply for a device that performs welding, arc welding, laser welding, brazing, soldering, plasma cutting, waterjet cutting, laser cutting, among others. Thus, one of sound engineering and judgment can choose power supplies other than a welding power supply departing from the intended scope of coverage of the embodiments of the subject invention.

With reference to the drawings, like reference numerals designate identical or corresponding parts throughout the several views. However, the inclusion of like elements in different views does not mean a given embodiment necessarily includes such elements or that all embodiments of the invention include such elements. The examples and figures are illustrative only and not meant to limit the invention, which is measured by the scope and spirit of the claims.

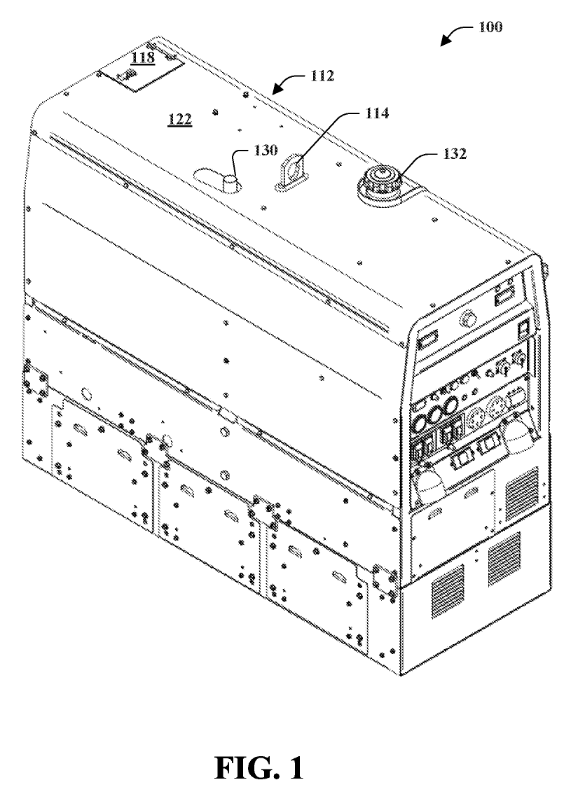

FIG. 1 illustrates a welding device 100. The welding device 100 includes a housing 112 which encloses the internal components of the welding device 100. Optionally, the welding type device 100 includes a loading eyehook 114 and/or fork recesses. The loading eyehook 114 and the fork recesses facilitate the portability of the welding device 100. Optionally, the welding-type device 100 could include a handle and/or wheels as a means of device mobility. The housing 112 can also include a plurality of access panels on a side of the welding device such as, but not limited to, top, bottom, front, back, left side and/or right side. Access panel 118 provides access to a top panel 122 of housing 112 while another access panel can provide access to a side of housing 112. In an embodiment, the welding device 100 can include an access panel is on one or both sides. These access panels can provide access to the internal components of the welding device 100 including, for example, a motor, a rotor/stator assembly, engine, components, circuits, wiring, an energy storage device suitable for providing welding-type power, among others. Moreover, one or more panels can include a louvered opening to allow for air flow through the housing 112.

The housing 112 of the welding-type device 100 also houses an internal combustion engine. The engine is evidenced by an exhaust port 130 and a fuel port 132 that protrude through the housing 112. The exhaust port 130 extends above the top panel 122 of the housing 112 and directs exhaust emissions away from the welding-type device 100. The fuel port 132 preferably does not extend beyond the top panel 122 or a side panel. Such a construction protects the fuel port 132 from damage during transportation and operation of the welding-type device 100. It is to be appreciated that the exhaust port 130 can be located on at least one of a top side (as depicted), bottom side, left side, right side, front side, or back side. Additionally, it is to be appreciated that the fuel port 132 can be located on at least one of a top side (as depicted), bottom side, left side, right side, front side, or back side.

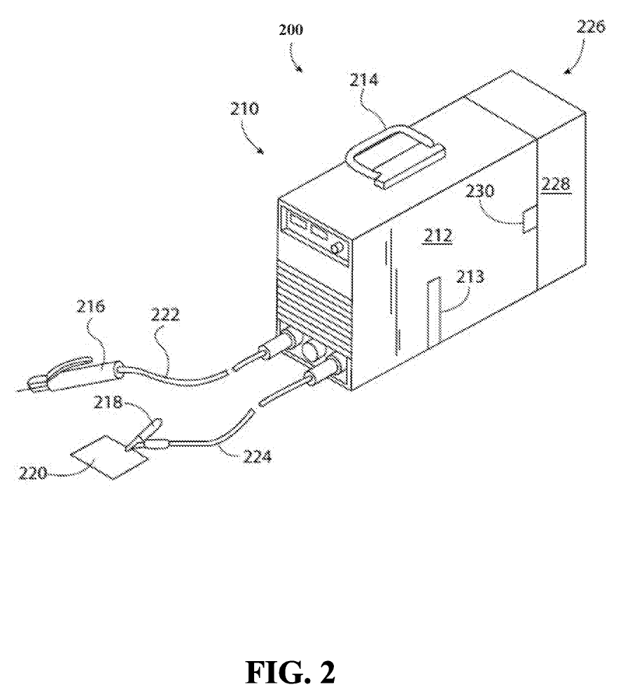

Referring now to FIG. 2, a perspective view of a welding apparatus 200 that can be utilized with the subject innovation. Welding apparatus 200 includes a power source 210 that includes a housing 212 enclosing the internal components of power source 210. As will be described in greater detail below, housing 212 encloses control components 213. Optionally, welding device 210 includes a handle 214 for transporting the welding system from one location to another. To effectuate the welding process, welding device 210 includes a torch 216 as well as a grounding clamp 218. Grounding clamp 218 is configured to ground a workpiece 220 to be welded. As is known, when torch 216 is in relative proximity to workpiece 220, a welding arc or cutting arc, depending upon the particular welding-type device, is produced. Connecting torch 216 and grounding clamp 218 to housing 212 is a pair of cables 222 and 224, respectively.

The welding arc or cutting arc is generated by the power source by conditioning raw power received from an interchangeable energy storage device 226. In a preferred embodiment, energy storage device 226 is a battery. Energy storage device 226 is interchangeable with similarly configured batteries. Specifically, energy storage device 226 is encased in a housing 228. Housing 228 is securable to the housing of welding device 210 thereby forming welding-type apparatus 200. Specifically, energy storage device 226 is secured to power source 210 by way of a fastening means 230. It is contemplated that fastening means 230 may include a clip, locking tab, or other means to allow energy storage device 226 to be repeatedly secured and released from power source 210.

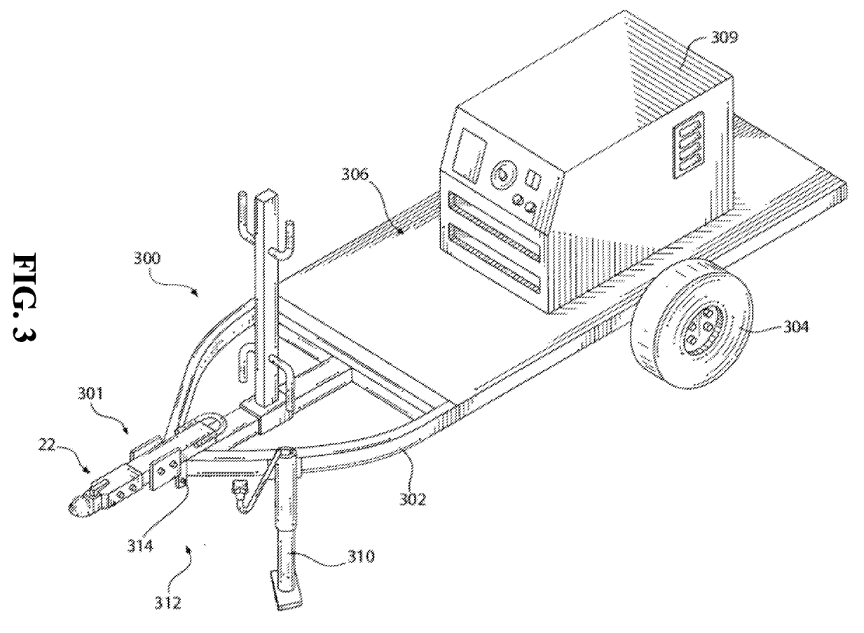

FIG. 3 illustrates a trailer 300 incorporating a trailer hitch or hitching device, depicted generally at 301. The trailer 300 may include a trailer frame 302 and one or more trailer wheels 304 in rotational connection with the trailer frame 302 and may further include a payload region 306 for carrying one or more cargo items, which in an exemplary manner may be a welding power supply 309 or an engine driven welding power supply 309. The trailer 300 may also include an adjustable stand 310 for adjusting the height of the front end 312 of the trailer 300. However, any means may be used for raising and/or lowering the front end 312 of the trailer 300. The trailer hitch 301 may be a generally longitudinal and substantially rigid trailer hitch 301 and may be attached to the frame 302 via fasteners 314, which may be threaded bolts.

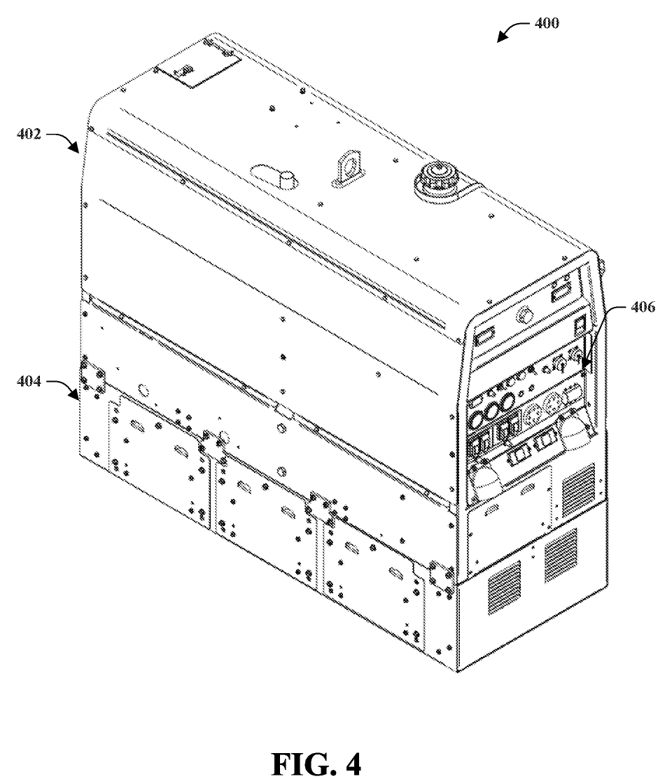

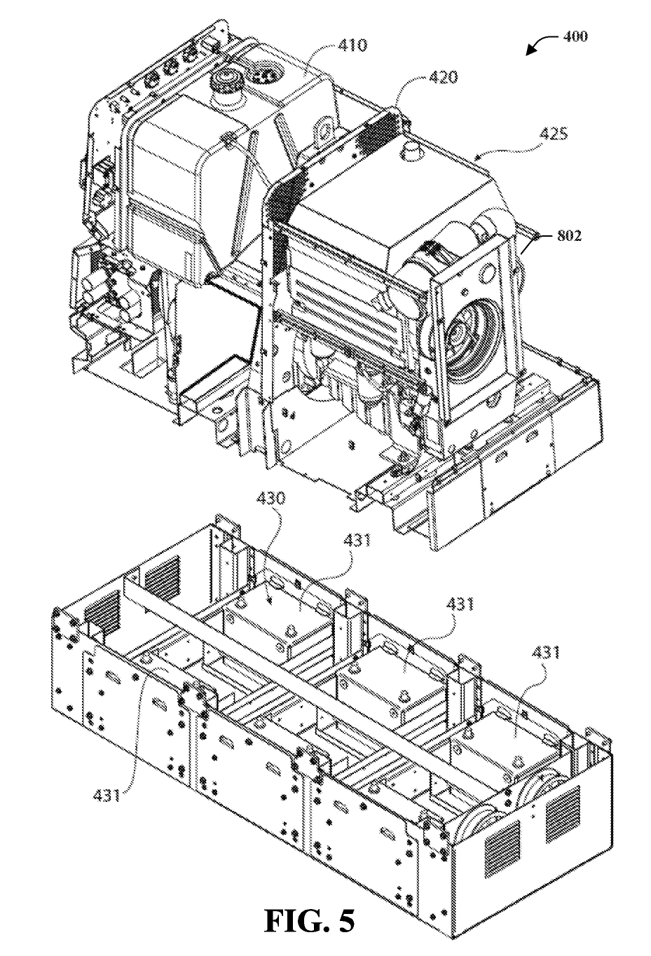

FIGS. 4 and 5 illustrate a hybrid welding device 400 (also referred to as a “hybrid welder”). A hybrid welder according to the invention is generally indicated by the number 400 in the drawings. Hybrid welder 400 is illustrated in FIG. 4 having the casing 112 and panels, whereas internals of hybrid welder 400 is illustrated in FIG, 5. Hybrid welder 400 in FIG. 4 can include an upper portion 402 and a lower portion 404, wherein the upper portion houses at least a portion of components associated with an engine component that utilizes a fuel to run and turn a shaft and the lower portion 404 can house at least one or more energy storage devices 430. The hybrid welder further includes a control panel 406 that can be located on a front face or side of the hybrid welder 400. The control panel 406 can allow settings to be configured via an input. By way of example and not limitation, the input can be buttons, keyboard, knobs, digital screen, touch screen, microphone for voice commands, connectors for welding components, switches, and the like.

Turning to FIG. 5, hybrid welder 400 includes an engine component that runs on fuel from fuel storage 410 allowing the hybrid welder 400 to be portable. It will be appreciated that hybrid welder 400 may also be mounted in a permanent location depending on the application, type of welding operation being performed, location of use for the welding, among others . Hybrid welder 400 generally includes an engine driven welder assembly 420 having an engine 425 and an energy storage device 430. Engine 425 may be an internal combustion engine operating on any known fuel including but not limited to gasoline, diesel, ethanol, natural gas, hydrogen, and the like. These examples are not limiting as other motors or fuels may be used. It is to be appreciated that, in an example, the engine 425 can be a motor or electrical motor.

The engine 425 and energy storage device 430 may be operated individually or in tandem to provide electricity for the welding operation and any auxiliary operations performed by hybrid welder 400. For example, individual operation may include operating the engine 425 and supplementing the power from the engine 425 with power from the energy storage device 430 on an as needed basis or supplying power from the energy storage device 430 alone when the engine 425 is offline. Tandem operation may also include combining power from engine 425 and energy storage device 430 to obtain a desired power output. According to one aspect of the invention, a welder 400 may be provided with an engine having less power output than ordinarily needed, and energy storage device 430 used to supplement the power output to raise it to the desired power output level. In an embodiment, an engine with no more than 19 kW (25 hp) output may be selected and supplemented with six 12 volt batteries. Other combinations of engine output may be used and supplemented with more or less power from energy storage device. The above example, therefore, is not limiting.

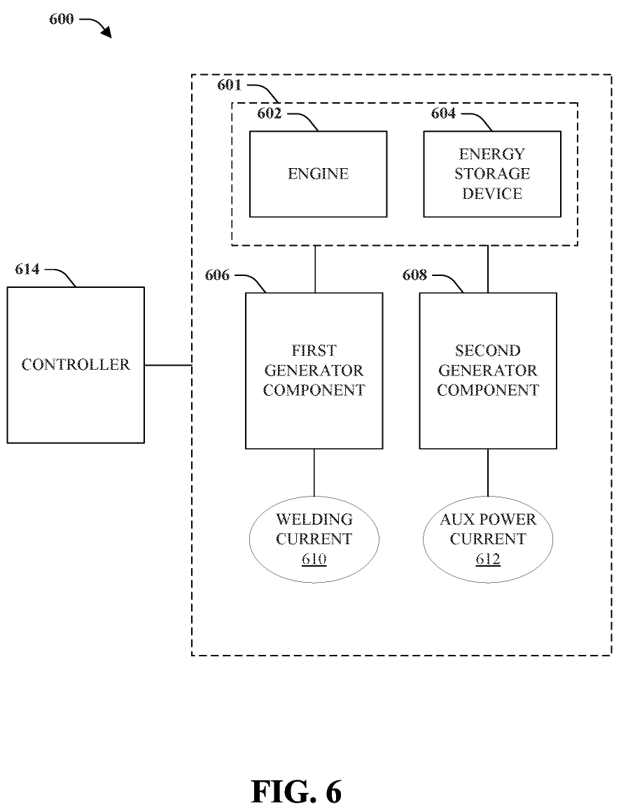

For instance, engine 425 can generate a voltage and such voltage can be stored in energy storage device 430. A controller 614 (illustrated in FIG. 6) can automatically select between engine 425 and energy storage device 430 for a power source for the welding operation performed by the hybrid welding device 400. In an embodiment, the switch component 630 can select between engine 425 and energy storage device 430 based upon a welding parameter (discussed below). For instance, the controller can detect a particular welding parameter and based on such detection and/or value, a selection for the power source can be determined and employed. It is to be appreciated that the power source can be selected by the controller to be one of the following: solely the engine 425; solely the energy storage device 430; or a combination of the engine 425 and the energy storage device 430. For example, a combination of the engine 425 and the energy storage device 430 can be a ratio pre-defined or determined in-situ of the welding operation based on the detected welding parameter. In one embodiment, the welding parameter can be received by the controller and the controller can be programmed to set the power source to be 35% engine 425 and 65% energy storage device 430. It is to be appreciated that the power source can be a percentage of one of the engine 425 and/or the energy storage device 430. It is to be discussed below that the controller utilize a switch component that is configured to select between the energy source 604 and one or more generators (as discussed in more detail below).

Energy storage device 430 may be any alternative power source including a secondary generator, kinetic energy recovery system, or, as shown, one or more batteries 431. In an embodiment, six 12 volt batteries 431 are wired in series to provide power in connection with engine driven welder assembly 420. Batteries 431 shown are lead acid batteries. Other types of batteries may be used including but not limited to NiCd, molten salt, NiZn, NiMH, Li-ion, gel, dry cell, absorbed glass mat, and the like.

FIG. 6 illustrates a block diagram of an aspect and portions of a welding device 600 that can be utilized by the subject innovation. The welding device 600 can be an embodiment of welding devices described in FIGS. 1-5. The welding device 600 can include a power source 601 that is configured to produce mechanical energy by combustion or by converting electrical energy or by delivering stored energy. It is to be appreciated that alternative fuels or green energy can be used or employed by the power source 601 to produce energy. By way of example and not limitation, the power source 601 can be a motor, an engine, a solar panel, an energy storage device, a battery device, a rotor/stator assembly, a combination thereof, among others. In a particular embodiment, the power source 601 can include an engine 602 and an energy storage device 604 (similar to the energy storage device 430 discussed above).

It is to be appreciated that an embodiment can include the power source 601 as the engine 602 without the energy storage device 604. In still another embodiment, the power source 601 can be solely the energy storage device 604. The engine 602 can convert electrical energy into mechanical energy and rotate a shaft. It is to be appreciated that the power source 601 can rotate a shaft to which a first generator component 606 is coupled and a second generator component 608 is coupled. The engine 602 can convert combustion energy into mechanical energy, wherein the engine 602 can be a heat combustion engine that burns a fuel. The energy storage device 604 can be used to store electrical energy that is used as an output for the power source 601 which is discussed in more detail below.

The welding device 600 can further include a first generator component 606 that is configured to produce a welding current 610 (also referred to as a first electrical current) that is used to perform a welding operation. In particular, the first generator component 606 is a permanent magnet and can include a rotor/stator assembly that is brushless. The rotor/stator assembly of the first generator component 606 can be configured to generate a first electrical current based on a rotation of a first rotor housed within a first stator. The first generator component 606 can be configured to generate the first electrical current that is sufficient to perform the welding operation. It is to be appreciated that a circuit component (discussed below) can be configured to adjust the welding current 610 to be used with a DC welding operation or an AC welding operation.

The welding device 600 can further include a second generator component 608 that is configured to produce an auxiliary power current 612 (also referred to as a second electrical current) that is used to power an auxiliary device. In particular, the second generator component 608 is an asynchronous generator and can include a rotor/stator assembly that is brushless. The rotor/stator assembly of the second generator component 608 can be configured to generate the second electrical current based on a rotation of a second rotor housed within a second stator. The aux power current 612 can be used for an auxiliary port or outlet to power or provide electricity to an external device. For example, the external device can connect via a cable, plug, or wireless receiver/transmitter located or associated with an auxiliary port, in an embodiment, the auxiliary power source is a component that is configured to deliver a pre-defined power output at a frequency and voltage.

Welding device 600 can be used to perform a welding operation, as well as provide an auxiliary power source, using the first generator component 606 and the second generator component 608, wherein each of the generators have respective rotor/stator assemblies with a particular configuration. The first generator component 606 rotor/stator assembly can have a particular permanent magnet configuration in which the stator slotting generates a first electrical current that is used to perform a welding operation. It is to be appreciated that the first electrical current can be produced by the first generator component 606 and delivered to a circuit component to adjust the first electrical current for use with a welding operation. In an embodiment, the first electrical current is produced, rectified, and delivered through an electronic switching device (e.g., MOSFET switch, etc.) for use with a DC welding operation (discussed in more detail below). Moreover, as discussed in more detail below, a portion of the first electrical current can be fed to excite the second generator component 608 after a frequency of the portion has been matched with a frequency of the second generator component 608. In particular, the portion of the first electrical current can be fed into a rotor of the second generator component 608.

Welding device 600 can provide an auxiliary power source using the second generator component 608, wherein the second generator component 608 has a respective rotor/stator assembly with a particular stator winding or permanent magnet configuration. In an embodiment, the second generator component 608 rotor/stator assembly can be asynchronous and generate a second electrical current that is used for an auxiliary power source. It is to be appreciated that the second electrical current produced by the second generator component 608 can be generated at a frequency configured based on a desired output for the auxiliary power source. For instance, the frequency can be, but is not limited to, 50 Hz, 60 Hz, 400 Hz, among others. In an example, the frequency can be 60 Hz with an auxiliary power source to have an output of at least one of 100 volts, 110 volts, 115 volts, 12.0 volts, 127 volts, 220 volts, 230 volts, 240 volts, a voltage in the range of 100 to 250, among others. In still another example, the frequency can be 50 Hz with an auxiliary power source to have an output of at least one of 100 volts, 220 volts, 230 volts, 240 volts, 100 volts, 110 volts, 115 volts, 120 volts, 127 volts, a voltage in the range of 100 to 250 volts, among others.

It is to be appreciated that each generator component (e.g., the first generator component 606 and the second generator component 608) can be at least one of a two pole design or a four pole design. Moreover, each generator component can include a design using any suitable number of poles. The subject innovation can be used with the first generator component 606 having a first rotor/stator assembly with a first stator configuration, the second generator component 608 having a second rotor/stator assembly with a second stator configuration, wherein the first stator configuration differs from the second stator configuration. It is to be appreciated that the subject innovation can be employed such that each of the first generator component 606 and the second generator 608 have the same stator configuration, different stator configurations, and/or multiple stator configurations.

In a particular example, a welding device can have a target output of 175 volts needed for the following: excitation voltage; welding voltage; and auxiliary voltage. In this example, welding voltage can be 15 volts, auxiliary power voltage can be 120 volts, and excitation voltage can be 40 volts. With the subject innovation, the first generator component 606 can be configured to generate the 15 volts for welding voltage and 40 volts for excitation voltage and the second generator component 608 can be configured to produce the 120 volts for auxiliary power voltage. It is to be appreciated that the excitation voltage of 40 volts can be adjusted to match the frequency to be used for excitation of the rotor/stator assembly of the second generator component 608. By way of example and not limitation, the welding voltage can be in a range of approximately 15 to 35 volts and excitation voltage can be in a range of approximately 40 to 120 volts.

Welding device 600 can further include a controller 614 that can be used to process one or more instructions using at least one processor and at least a memory in order to perform a welding operation, manage (e.g., distribute, regulate, etc.) power received from the first generator component 606 and/or the second generator component 608, process instructions related to operation of the welding device 600, adjust settings from a control panel to adjust a welding parameter, producing the first electrical current (e.g., welding current 610) and/or the second electrical current (e.g., aux power current 612), performing a welding operation with the first electrical current, delivering the second electrical current for the auxiliary power source, generating a waveform to perform the welding operation, among others. The controller 614 can control a wire feeder, the power source 601, field controller component, an auxiliary port or plug, among others

In still another example, described below, the controller 612 can decrease at least one of the frequency or the engine speed based on reducing fuel consumption for the engine. For example, a consumed fuel tank level or amount can be set to indicate that consumed fuel should be conserved. In order to conserve the consumed fuel, the controller 614 can reduce engine revolutions per minute (RPM) and/or frequency, wherein the controller 614 can employ adjustments to the output of the first generator component 606 or the second generator component 608 to maintain a target output to be used for a welding operation or the auxiliary power source, among others.

Additionally or alternatively, the controller 614 can adjust the frequency or the engine speed based on a welding parameter for at least one of the first generator component 606 or the second generator component 608. By way of example, the welding parameter can be, a type of use fur an output (e.g., welding output, DC output for a welding operation, AC output for a welding operation, auxiliary power source, output for an auxiliary power source, output for a device electronically coupled to the auxiliary power source, or a combination thereof), a voltage setting for a welding operation, a frequency for a welding operation, current setting for a welding operation, a type of welding operation, a type of shielding gas, a material composition of workpiece W, a welding pattern, a type of electrode, a fuel tank level, an amount of charge in an energy storage device, a percentage of generating the output between the engine 602 and the energy storage device 604, a composition of electrode, a wire feed speed, a waveform used for the welding operation, a polarity of a welding wire, a type of flux, a number of electrodes used in the welding operation, an arc voltage, a travel speed of a tractor welder that performs the welding operation, a travel speed of a torch that performs the welding operation, an arc current level, a height of torch, a distance between workpiece W and torch or an end of the electrode, an oscillation width of electrode, a temperature of welding wire, a temperature of electrode, a type of material of workpiece W, a frequency of oscillation of electrode, a polarity of the arc current, a polarity of the current for welding wire, a parameter that affects an arc current of the welding operation, a gauge of wire, a material of wire, an oscillation dwell, a left oscillation dwell, a right oscillation dwell, one or more temperatures of workpiece W at one or more locations on workpiece W, a temperature of workpiece W, any and all variation of advanced process controls (e.g., move controls, pulse-frequency, ramp rates, background level ratios, etc.), and the like.

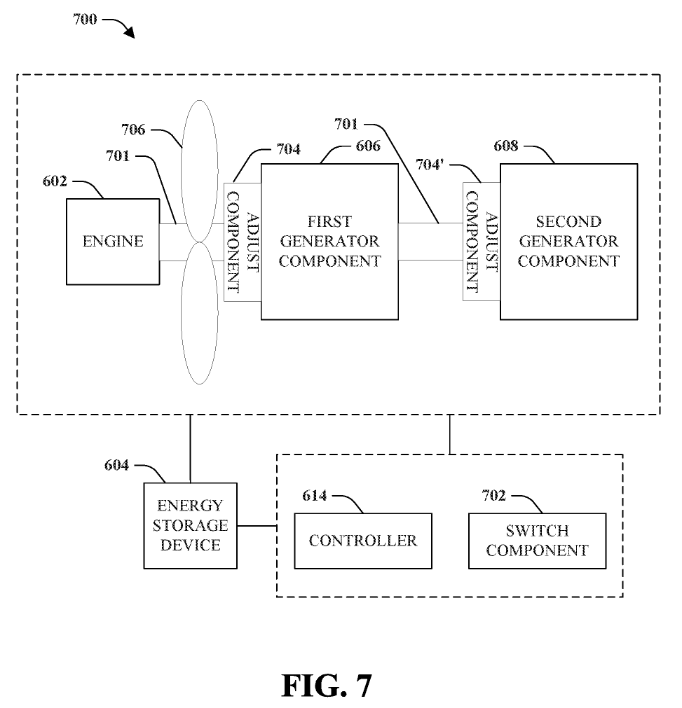

FIG. 7 illustrates an aspect of a welding device or a portion of a welding system 700 that includes the first generator component 606 and the second generator component 608. The welding system 700 can include the engine 602 can be configured to provide rotational movement to a shaft 701, wherein the first generator component 606 and the second generator component 608 are couple thereto. By way of example and not limitation, the engine 602 can convert combustion energy into mechanical energy by burning a fuel. It is to be appreciated that the engine 602 can provide rotational movement to the shaft 701.

In response to the rotational movement, the shaft 701 rotates as does a first rotor/stator assembly associated with the first generator component 606 and a second rotor/stator assembly associated with the second generator component 608. The first generator component 606 and the second generator component 608 can be independently coupled to the shaft 701. As discussed above, the first generator component 606 can be brushless and be a permanent magnet generator with a stator that has permanent magnets slotted in positions to which a rotor rotates around from rotational movement from the shaft 701. Moreover, also discussed above, the second generator component 608 can be brushless and be an asynchronous generator.

The first generator component 606 is configured to provide electrical power in a condition that is compatible for a welding operation in at least one of a DC welding operation or an AC welding operation. The second generator component 608 is configured to provide electrical power in a condition that is compatible for an auxiliary power source. For example, AC electrical power is generally required to be at 60 Hz in North America and at 50 Hz in Europe and most of Asia. As such, the second generator component 608 may be configured to provide auxiliary power at or about 50 or 60 Hz. There are generally accepted tolerances in electrical-mechanics as to the frequency of AC power. When referring to the auxiliary power at or about 50 or 60 Hz, it must be understood that one skilled in the art of electrical-mechanical devices will understand the range upon which such a device may operate.

The welding device 700 can include a switch component 702 that is configured to select between at least one of the energy storage device 604, the first generator component 606, or the second generator component 608 based upon a welding parameter (discussed above) or a type of output (e.g., welding output, DC output for a welding operation, AC output for a welding operation, auxiliary power source, output for an auxiliary power source, output for a device electronically coupled to the auxiliary power source, or a combination thereof). By way of example, the switch component 702 can select from the energy storage device 604, the first generator component 606, or the second generator component 608 to produce the first electrical current (e.g., used for performing a welding operation) and/or the second electrical current (e.g., used as the auxiliary power source).

The system 700 includes a first speed adjust component 704 and a second speed adjust component 704′ (collectively referred to as speed adjust component 704 or adjust component 704). The first speed adjust component 704 can control a speed or rotation of the first generator component 606 (and in turn the rotor/stator assembly associated therewith), whereas the second speed adjust component 704′ can control a speed or rotation of the second generator component 608 (and in turn the rotor/stator assembly associated therewith). It is to be appreciated that there can be a first speed adjust component 704 and a second speed adjust component 704′ (as depicted) or a speed adjust component that controls both the speed of the first generator component 606 and the second generator component 608 together or independently. The speed adjust component 704 can include a transmission or gearing to allow for the first rotor/stator assembly of the first generator component 606 to rotate at a first speed and the second rotor/stator assembly of the second. generator component 608 to rotate at a second speed. Moreover, it is to be appreciated that the speed adjust component 704 can be located at various locations on the shaft 701 and such location can be selected on the shaft 701 with sound engineering judgment.

The speed adjust component 704 can couple the first generator component 606 and/or the second generator component 608 to the rotational power output of the engine 602. The speed adjust component 704 is configured to drive the first generator component 606 and the second generator component 608 at different rotational rates than a rotational rate of the rotational power output of the engine 602.

For example, the speed adjust component 704 may include a pulley system. The pulley system may have a first pulley connected to the rotational power output of the engine 602, a second pulley connected to an input of the first generator component 606 and a third pulley connected to an input of the second generator component 608. The pulleys may be sized to create the desired drive ratio between the engine 602, the first generator component 606, and the second generator 608. The pulleys may be coupled by at least one of a cable, a belt and a chain or any other device suitable to transmit power from one pulley to another.

For further example, the speed adjust component 704 include a transmission. The transmission may include several manually or automatically selectable gears to provide for multiple gear ratios. Alternatively, the transmission may include a continuously variable transmission that is manually or automatically set to a desired output speed and then adjusts to the input speed from the output of the engine 602.

In one embodiment, the speed adjust component 704 allows the engine 602 to run at a relatively low rate for the generation of AC current for welding by the first generator component 606 while providing a relatively higher rotational speed to second generator component 608 that produces the power for the auxiliary power source.

The system 700 can further include a fan 706 to cool the first generator component and the second generator component 608. It is to be appreciated that the shape and size of the fan 706 can be selected by sound engineering and judgment. Moreover, the fan 706 can be located that is at least one of between the engine 602 and the first generator component 606 (as depicted), between the first generator component 606 and the second generator component 608, on a side opposite of the engine 602 and proximate to the second generator component 608, or a combination thereof. In another embodiment, the system 700 can include one or more fans 706 to cool the first generator component 606 and the second generator component 608.

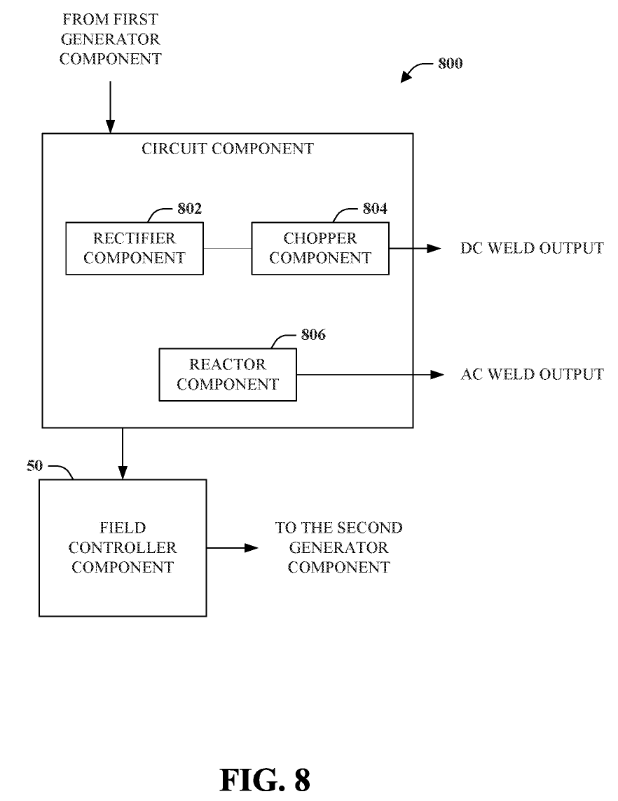

FIG. 8 illustrates a circuit component 800 that can be used with a welding device or welding system in accordance with the subject innovation. The circuit component 800 can adjust the first electrical current from the first generator component 606 to be used in at least one of a DC weld operation or an AC weld operation. For example, a controller can receive a signal to indicate whether an AC weld operation is to be performed or a DC weld operation is to be performed. Based on such signal, the circuit component 800 can adjust the first electrical current. Moreover, the first electrical current can include a first portion that is utilized for either a DC weld operation or an AC weld operation and a second portion that is utilized to excite the second generator component 608.

The circuit component 800 can receive a first portion of the first electrical current from the first generator component 606, wherein the first portion of the first electrical current is used to perform a welding operation. The first portion of the first electrical current can be rectified by the rectifier component 802 and then passed through a chopper component 804 for use to perform a DC weld operation (e.g., DC weld output) if the signal indicates a DC weld operation. In another embodiment, the circuit component 800 can provide AC weld operation functionality. The first portion of the first electrical current can be passed through a reactor component 806 for use to perform an AC weld operation (e.g., AC weld output) if the signal indicates an AC weld operation.

A field controller component 50 can be employed with the circuit component 800 to feed excitation voltage to the second generator component 608. In particular, a second portion of the first electrical current can be adjusted to a frequency that matches a frequency of the second generator component 608 and used for excitation of the rotor/stator assembly thereof.

It is to be appreciated that welding device or welding systems described above can include one or more circuits, circuitry, components, field controller components, or a combination thereof. It is to be appreciated that there can be a field controller component for each rotor/stator assembly used by the welding device described therein or a welding system. It is to be appreciated that a circuit or circuitry can be used upon receipt of the first electrical current and/or the second electrical current in order to adapt for the particular functionality (e.g., performing a welding operation, used for an auxiliary power source). By way of example and not limitation, a welding circuitry for the first electrical current received from the first generator component 606 can be used and an auxiliary power circuitry for the second electrical current received from the second generator component 608 can be used.

It is to be appreciated that the field controller component 50 can be a stand-alone component within welding device (as depicted), incorporated into the controller 614, incorporated into circuitry or components related to adjusting the output from the first generator component 606 or the second generator component 608 (e.g., welding current, auxiliary power current, etc.), incorporated into the first generator component 606, incorporated into the second generator component 608, incorporated into the circuit component 800, or a combination thereof.

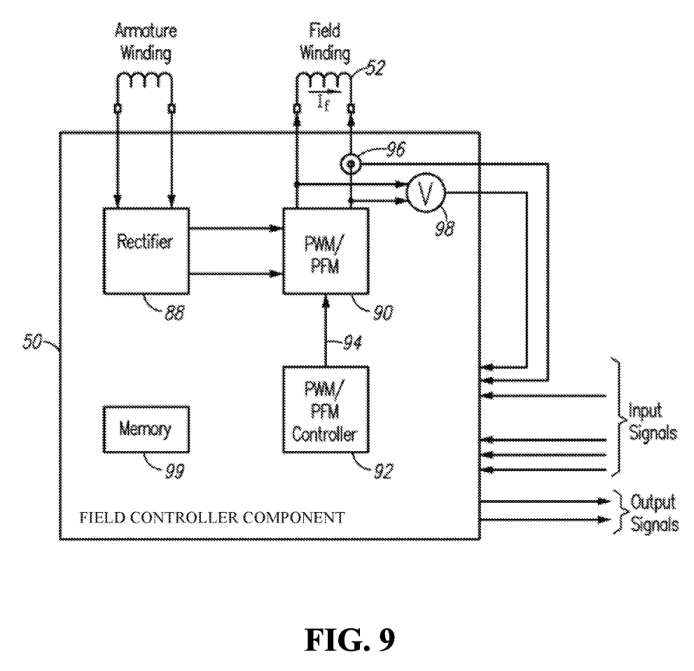

FIG. 9 provides a schematic diagram of an example field controller 50. The field controller 50 receives power from an armature winding of the first generator component 606. The armature winding can be one of the windings that supplies power to be used for a welding operation. A rectifier 88 rectifies the AC voltage from the armature winding. The rectified voltage is provided to a pulse modulation switching device 90, such as a PWM or pulse-frequency modulation (PFM) switching device. The output of the pulse modulation switching device 90 is a pulse modulated signal (PWM or PFM) that generates the field current I^{f} in the field winding 52 associated with the second generator component 608. The field controller 50 includes a PWM or PFM controller that provides a control signal 94 to the pulse modulation switching device 90, to thereby control the magnitude of the field current I^{f}. For example, the magnitude of the field current I^{f} can be adjusted to match a frequency the second generator component 608 is operating. In another embodiment, the magnitude of the field current I^{f} can be adjusted based on various input signals. By way of example and not limitation, the field controller 50 receives various input signals such as energy storage device voltage, energy storage device current, DC bus voltage, ambient/energy storage device temperature, etc. The field controller 50 can also monitor the field current if via a current sensor 96 and monitor the voltage across the field winding via a voltage sensor 98. The field controller 50 can provide output signals to various devices or components related to the welding device described above. The field controller 50 further includes a memory portion 99 for storing program instructions, operating parameters, and the like.

In an embodiment, the first generator component is a permanent magnet generator. In an embodiment, the second generator component is an asynchronous generator. In an embodiment, a fan is provided that rotates to cool the first generator component and the second generator component, wherein the fan is coupled to the shaft to provide such rotation. In an embodiment, a first circuit is provided that is configured to adjust the first portion of the electrical current to perform a DC welding operation. In an embodiment, a circuit is provided that is configured to adjust the first portion of the electrical current to perform an AC welding operation. In an embodiment, the circuit is configured to regulate a speed of the engine. In an embodiment, the circuit in configured to use a reactor to convert the first portion of the electrical current to perform the AC welding operation.

In an embodiment, a speed adjust component is provided that is configured to adjust a rotational speed of at least one of the first rotor or the second rotor via the engine and shaft. In an embodiment, the speed adjust component is configured to maintain a first speed for the first rotor and a second speed for the second rotor. In an embodiment, a field controller component is provided that is configured to: receive a second portion of the first electrical current at a first frequency; convert the second portion of the first electrical current to a second frequency; and deliver the converted second portion to the second generator component for use to excite a field coil of the second stator of the second generator, wherein the second generator is running at the second frequency. In an embodiment, the first frequency is in a range of 250 Hz to 900 Hz. In an embodiment, the second frequency is at least one of 50 Hz, 60 Hz, or 400 Hz. In an embodiment, an energy storage device is provided that is configured to store at least one of a portion of the first electrical current or a portion of the second electrical current.

In an embodiment, a switch component is provided that selects between at least one of the following based on a welding parameter: the first electrical current or the second electrical current that is stored with the energy storage device for use with the welding operation; the first electrical current or the second electrical current that is stored with the energy storage device for use as the auxiliary power source; the first electrical current that is stored with the energy storage device or the first electrical current that is generated by the first generator component for use with the welding operation; the second electrical current that is stored with the energy storage device or the second electrical current that is generated by the second generator component for use as the auxiliary power source; the first electrical current that is generated by the first generator component for use with the welding operation and the second electrical current that is generated by the second generator component for use as the auxiliary power source; or the first electrical current or the second electrical current that is stored with the energy storage device is fed to the second generator for excitation at a matched frequency of the second electrical current.

The aforementioned systems, components. (e.g., field controller component 614, controller 612, power source 602, rotor/stator assembly 606, energy storage device 608, welding device 600, among others), and the like have been described with respect to interaction between several components and/or elements. It should be appreciated that such devices and elements can include those elements or sub-elements specified therein, some of the specified elements or sub-elements, and/or additional elements. Further yet, one or more elements and/or sub-elements may be combined into a single component to provide aggregate functionality. The elements may also interact with one or more other elements not specifically described herein.

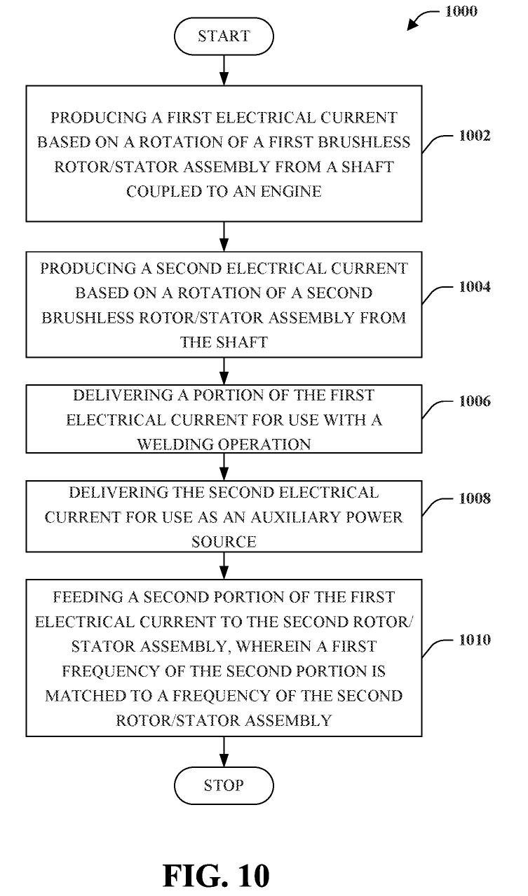

In view of the exemplary devices and elements described supra, methodologies that may be implemented in accordance with the disclosed subject matter will be better appreciated with reference to the flow chart(s) of FIG. 10. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

FIG. 10 illustrates a methodology that can be implemented with one or more welding devices discussed in FIGS. 1-7 or circuitry (illustrated in FIGS. 8 and/or 9), a welding device or system that uses features as described above.

Sequentially, the following occurs as illustrated in the decision tree flow diagram 1000 of FIG. 10 which is a flow diagram 1000 that utilizing two brushless generators to generate power for a welding operation and an auxiliary power source respectively. At reference block 1002, a first electrical current is produced based on a rotation of a first brushless rotor/stator assembly from a shaft coupled to an engine, wherein the engine is part of a welding device. At reference block 1004, a second electrical current is produced based on a rotation of a second brushless rotor/stator assembly from the shaft. At reference block 1006, a portion of the first electrical current is delivered for use with a welding operation. At reference block 1008, the second electrical current is delivered for use as an auxiliary power source. At reference block 1010, a second portion of the first electrical current is fed to the second rotor/stator assembly, wherein a first frequency of the second portion is matched to a frequency of the second rotor/stator assembly.

In an embodiment, the first frequency is in a range of 250 Hz to 900 Hz and the second frequency is at least one of 50 Hz, 60 Hz, or 400 Hz. In an embodiment, the method can include selecting, based on a welding parameter, between the first rotor/stator assembly, a second rotor/stator assembly, or an energy storage device for use to perform the welding operation or for use as the auxiliary power source. In an embodiment, the method can include cooling the first rotor/stator assembly and the second rotor/stator assembly with a fan rotated by being coupled to the shaft.

While the embodiments discussed herein have been related to the systems and methods discussed above, these embodiments are intended to be exemplary and are not intended to limit the applicability of these embodiments to only those discussions set forth herein. The control systems and methodologies discussed herein are equally applicable to, and can be utilized in, systems and methods related to arc welding, laser welding, brazing, soldering, plasma cutting, waterjet cutting, laser cutting, and any other systems or methods using similar control methodology, without departing from the spirit or scope of the above discussed inventions. The embodiments and discussions herein can be readily incorporated into any of these systems and methodologies by those of skill in the art. By way of example and not limitation, a power supply as used herein (e.g., welding power supply, among others) can be a power supply for a device that performs welding, arc welding, laser welding, brazing, soldering, plasma cutting, waterjet cutting, laser cutting, among others. Thus, one of sound engineering and judgment can choose power supplies other than a welding power supply departing from the intended scope of coverage of the embodiments of the subject invention.

The above examples are merely illustrative of several possible embodiments of various aspects of the present invention, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the invention. In addition although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

The best mode for carrying out the invention has been described for purposes of illustrating the best mode known to the applicant at the time and enable one of ordinary skill in the art to practice the invention, including making and using devices or systems and performing incorporated methods. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A welding device, comprising:
a motor-driven welder assembly including an engine that is configured to rotate a shaft;
a first generator component having a first rotor coupled to the shaft and a first stator that houses the first rotor, wherein a rotation from the shaft rotates the first rotor to generate a first electrical current;
a second generator component having a second rotor coupled to the shaft and a second stator that houses the second rotor, wherein the rotation from the shaft rotates the second rotor to generate a second electrical current;
the first generator component and the second generator component are brushless;
the second electrical current is used as an auxiliary power source; and
a first portion of the first electrical current is used as a power source for the welding device to perform a welding operation.

2. The welding device of claim 1, wherein the first generator component is a permanent magnet generator.

3. The welding device of claim wherein the second generator component is an asynchronous generator.

4. The welding device of claim 1, further comprising a fan that rotates to cool the first generator component and the second generator component, wherein the fan is coupled to the shaft to provide such rotation.

5. The welding device of claim 1, further comprising a first circuit that is configured to adjust the first portion of the electrical current to perform a DC welding operation.

6. The welding device of claim 1, further comprising a circuit that is configured to adjust the first portion of the electrical current to perform an AC welding operation.

7. The welding device of claim 6, wherein the circuit is configured to regulate a speed of the engine.

8. The welding device of claim 7, wherein the circuit in configured to use a reactor to convert the first portion of the electrical current to perform the AC welding operation.

9. The welding device of claim 1, further comprising a speed adjust component that is configured to adjust a rotational speed of at least one of the first rotor or the second rotor via the engine and shaft.

10. The welding device of claim 9, wherein the speed adjust component is configured to maintain a first speed for the first rotor and a second speed for the second rotor.

11. The welding device of claim 1, further comprising a field controller component that is configured to:
receive a second portion of the first electrical current at a first frequency;
convert the second portion of the first electrical current to a second frequency; and
deliver the converted second portion to the second generator component for use to excite a field coil of the second stator of the second generator, wherein the second generator is running at the second frequency.

12. The welding device of claim 11, wherein the first frequency is in a range of 250 Hz to 900 Hz.

13. The welding device of claim 12, wherein the second frequency is at least one of 50 Hz, 60 Hz, or 400 Hz.

14. The welding device of claim 1, further comprising an energy storage device that is configured to store at least one of a portion of the first electrical current or a portion of the second electrical current.

15. The welding device of claim 14, further comprising a switch component that selects between at least one of the following based on a welding parameter:
the first electrical current or the second electrical current that is stored with the energy storage device for use with the welding operation;
the first electrical current or the second electrical current that is stored with the energy storage device for use as the auxiliary power source;
the first electrical current that is stored with the energy storage device or the first electrical current that is generated by the first generator component for use with the welding operation;
the second electrical current that is stored with the energy storage device or the second electrical current that is generated by the second generator component for use as the auxiliary power source;
the first electrical current that is generated by the first generator component for use with the welding operation and the second electrical current that is generated by the second generator component for use as the auxiliary power source; or
the first electrical current or the second electrical current that is stored with the energy storage device is fed to the second generator for excitation at a matched frequency of the second electrical current.

16. A method for an engine driven welding device, comprising:
producing a first electrical current based on a rotation of a first brushless rotor/stator assembly from a shaft coupled to an engine;
producing a second electrical current based on a rotation of a second brushless rotor/stator assembly from the shaft;
delivering a first portion of the first electrical current for use with a welding operation;
delivering the second electrical current for use as an auxiliary power source; and
feeding a second portion of the first electrical current to the second brushless rotor/stator assembly, wherein a first frequency of the second portion is matched to a second frequency of the second brushless rotor/stator assembly.

17. The method of claim 16, wherein the first frequency is in a range of 250 Hz to 900 Hz and the second frequency is at least one of 50 Hz; 60 Hz, or 400 Hz.

18. The method of claim 16, further comprising selecting, based on a welding parameter, between the first rotor/stator assembly, a second rotor/stator assembly, or an energy storage device for use to perform the welding operation or for use as the auxiliary power source.

19. The method of claim 16, further comprising cooling the first rotor/stator assembly and the second rotor/stator assembly with a fan rotated by being coupled to the shaft.

20. A welding system, comprising:
means for rotating a shaft;
a first generator component having a first rotor coupled to the shaft and a first stator that houses the first rotor, wherein a rotation from the shaft rotates the first rotor to generate a first electrical current;
a second generator component having a second rotor coupled to the shaft and a second stator that houses the second rotor, wherein the rotation from the shaft rotates the second rotor to generate a second electrical current;
the first generator component and the second generator component are brushless;
the second electrical current is used as an auxiliary power source;
a first portion of the first electrical current is used as a power source for the welding device to perform a welding operation; and
a field controller component that is configured to convert a second portion of the first electrical current to a frequency that matches a frequency the second generator component is running and excites the second generator component using the converted second portion.
